(19) United States
(12) Patent Application Publication
(10) Pub. No.: US 2022/0284707 A1
(43) Pub. Date: Sep. 8, 2022

(54) TARGET DETECTION AND CONTROL METHOD, SYSTEM, APPARATUS AND STORAGE MEDIUM

(71) Applicant: Beijing Roborock Technology Co., Ltd., Beijing (CN)

(72) Inventor: Haojian XIE, Beijing (CN)

(21) Appl. No.: 17/716,826

(22) Filed: Apr. 8, 2022

Related U.S. Application Data
(63) Continuation of application No. PCT/CN2021/100722, filed on Jun. 17, 2021.

(30) Foreign Application Priority Data
Mar. 8, 2021 (CN) 202110264971.7

(51) Int. Cl. G06V 20/50; G06V 10/143; G06V 10/74; G06T 7/70; G06T 7/00; H04N 5/235; G06T 7/521; G06V 10/762; G05D 1/02

(52) U.S. Cl. CPC G06V 20/50; G06V 10/143; G06V 10/761; G06T 7/70; G06T 7/0002; H04N 5/2353; G06T 7/521; G06V 10/762; G05D 1/0248; G06V 2201/121; G06V 2201/07; G06T 2207/30168; G06T 2207/10028; G05D 2201/0217

(57) ABSTRACT

The present disclosure provides a target detection, apparatus, system, device and readable storage medium and relates to the technical field of computer vision. The method may include acquiring a first image captured by an imaging device, wherein the first image is captured when a laser light of a first predetermined wavelength is emitted; acquiring a second image captured by the imaging device, wherein the second image is captured when a light of a second predetermined wavelength is emitted, and the laser light of the first predetermined wavelength and the light of the second predetermined wavelength have a same wavelength or different wavelengths; obtaining a distance between a target object and the imaging device based on the first image; and identifying the target object based on the second image.

### CROSS-REFERENCE TO RELATED APPLICATIONS

The present disclosure is a continuation application of International Application No. PCT/CN2021/100722, filed on Jun. 17, 2021, which is based on and claims priority to Chinese Patent Application No. 202110264971.7, filed with the Chinese Patent Office on Mar. 8, 2021, titled “TARGET DETECTION AND CONTROL METHOD, SYSTEM, APPARATUS AND STORAGE MEDIUM”, both of which are incorporated herein by reference in its entirety for all purposes.

### TECHNICAL FIELD

The present disclosure relates to the technical field of computer vision, and in particular, to a target detection and control method, system, apparatus, and readable storage medium.

### BACKGROUND

Intelligent self-propelled equipment usually adopts advanced navigation technology to realize autonomous driving. As one of the basic technologies, Simultaneous Localization and Mapping (SLAM) is widely used in autonomous driving, robots, and drones.

So far, how to improve the rationality of obstacle avoidance path planning is still an urgent problem to be solved.

The above information disclosed in this Background section is only for enhancement of understanding of the background of the disclosure and therefore it may contain information that does not form the prior art that is already known to a person of ordinary skill in the art.

### SUMMARY

According to a first aspect of the embodiments of the present disclosure, there is provided a target detection method. The target detection method may include: acquiring a first image captured by an imaging device, wherein the first image is captured when a laser light of a first predetermined wavelength is emitted; acquiring a second image captured by the imaging device, wherein the second image is captured when a light of a second predetermined wavelength is emitted, and the laser light of the first predetermined wavelength and the light of the second predetermined wavelength have a same wavelength or different wavelengths; obtaining a distance between a target object and the imaging device based on the first image; and identifying the target object based on the second image.

According to a second aspect of the embodiments of the present disclosure, there is provided a target detection control method. The target detection control method may include: controlling to turn on a laser emitting device and a light-compensating device alternately, wherein a first image is captured by an imaging device when the laser emitting device is turned on, and a second image is captured by the imaging device when the light-compensating device is turned on; the laser emitting device is configured to emit a laser light of a first predetermined wavelength, and the light-compensating device is configured to emit a light of a second predetermined wavelength; obtaining a distance between a target object and the imaging device based on the first image; and identifying the target object based on the second image.

According to a third aspect of the embodiments of the present disclosure, there is provided a target detection system. The target detection system may include a laser emitting device, a light-compensating device, an imaging device and a target detection device, wherein the laser emitting device is configured to emit a laser light of a first predetermined wavelength; the light-compensating device is configured to emit a light of a second predetermined wavelength, and the laser light of the first predetermined wavelength and the light of the second predetermined wavelength have a same wavelength or different wavelengths; the imaging device is configured to capture a first image when the laser light of the first predetermined wavelength is emitted, and capture a second image when the light of the second predetermined wavelength is emitted; the target detection device may include a ranging module configured to obtain a distance between a target object and the imaging device based on the first image; and an object identification module configured to identify the target object based on the second image.

It should be understood that the above general descriptions and the detailed descriptions below are only illustrative and do not limit this disclosure.

### BRIEF DESCRIPTION OF THE DRAWINGS

The above and other objects, features and advantages of the present disclosure will become more apparent from the detailed description of example embodiments thereof with reference to the accompanying drawings.

FIG. 1A shows a schematic diagram of a target detection system in an embodiment of the present disclosure.

FIG. 1B shows a graph of transmittance versus wavelength of an optical filter according to an exemplary embodiment.

FIG. 1C shows a left side view of the exemplary system of FIG. 1A.

FIG. 2 shows a flowchart of a target detection method in an embodiment of the present disclosure.

FIG. 3A shows a schematic flowchart of a time-division control performed by a target detection system in an embodiment of the present disclosure.

FIG. 3B shows a schematic flowchart of time-division control performed by another target detection system in an embodiment of the present disclosure.

FIG. 3C shows a timing diagram of time-division control in an embodiment of the present disclosure according to FIG. 3B.

FIG. 3D shows a schematic flowchart of time-division control performed by yet another target detection system according to an embodiment of the present disclosure.

FIG. 3E shows a schematic flowchart of time-division control performed by yet another target detection system according to an embodiment of the present disclosure.

FIG. 4 is a flow chart of an obstacle avoidance method for self-propelled equipment according to an exemplary embodiment.

FIG. 5 shows a block diagram of a target detection apparatus in an embodiment of the present disclosure.

FIG. 6 shows a block diagram of another target detection apparatus in an embodiment of the present disclosure.

FIG. 7 shows a schematic structural diagram of an electronic device in an embodiment of the present disclosure.

### DETAILED DESCRIPTION

Example embodiments will now be described more fully with reference to the accompanying drawings. Example embodiments, however, can be embodied in various forms and should not be construed as limited to the examples set forth herein; rather, these embodiments are provided so that this disclosure will be thorough and complete, and will fully convey the concept of example embodiments to those skilled in the art. The drawings are merely schematic illustrations of the present disclosure and are not necessarily drawn to scale. The same reference numerals in the drawings denote the same or similar parts, and thus their repeated descriptions will be omitted.

Furthermore, the described features, structures, or characteristics may be combined in one or more embodiments in any suitable manner. In the following description, numerous specific details are provided in order to give a thorough understanding of the embodiments of the present disclosure. However, those skilled in the art will appreciate that the technical solutions of the present disclosure may be practiced without one or more of the specific details, or other methods, devices, steps, etc. may be employed. In other instances, well-known structures, methods, devices, implementations, or operations have not been shown or described in detail to avoid obscuring aspects of the present disclosure.

In addition, the terms “first”, “second”, etc. are used for descriptive purposes only, and should not be construed as indicating or implying relative importance or implying the number of indicated technical features. Thus, feature defined as “first” or “second” may be used to expressly or implicitly include one or more of that feature. In the description of the present disclosure, “plurality” means at least two, such as two, three, etc., unless expressly and specifically defined otherwise. The symbol “I” generally indicates that the related objects are in an “or” relationship.

In the present disclosure, unless otherwise expressly specified and limited, terms such as “connect” should be interpreted in a broad sense, for example, it may be an electrical connection or may communicate with each other; it may be directly connected or indirectly connected through an intermediate medium. For those of ordinary skill in the art, the specific meanings of the above terms in the present disclosure can be understood according to specific situations.

Some related technologies use laser radar to perform an obstacle ranging. The laser radar needs to be rotated frequently and is easily damaged. Moreover, the laser radar is bulged on the top of the self-propelled equipment, which increases the height of the self-propelled equipment, and then only obstacles at or above its height can be sensed due to the set location of the self-propelled equipment. In other related technologies, intelligent self-propelled equipment uses line laser or structured light to perform the obstacle ranging, which cannot identify obstacles and may affect the obstacle avoidance strategy for obstacles with low heights, resulting in the movement path planned for the intelligent self-propelled equipment is unreasonable. Therefore, the present disclosure provides a target detection method, by acquiring a first image captured by an imaging device when emitting a laser light of a first predetermined wavelength and a second image captured by the imaging device when emitting a light of a second predetermined wavelength, obtaining a distance between a target object or an object and the imaging device based on the first image, and identifying the target object based on the second image, so that the obstacle identification or obstacle recognition can be performed while ranging (i.e., measuring the distance between the target object and the imaging device), and the rationality of obstacle avoidance path planning can be improved.

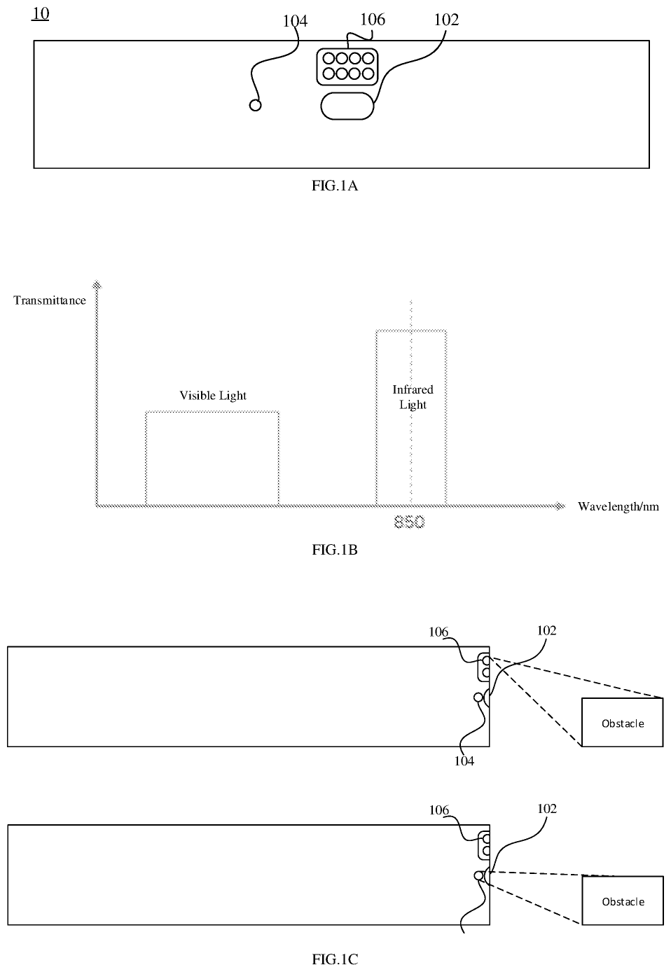

FIG. 1A shows an exemplary target detection system to which the target detection method of the present disclosure may be applied.

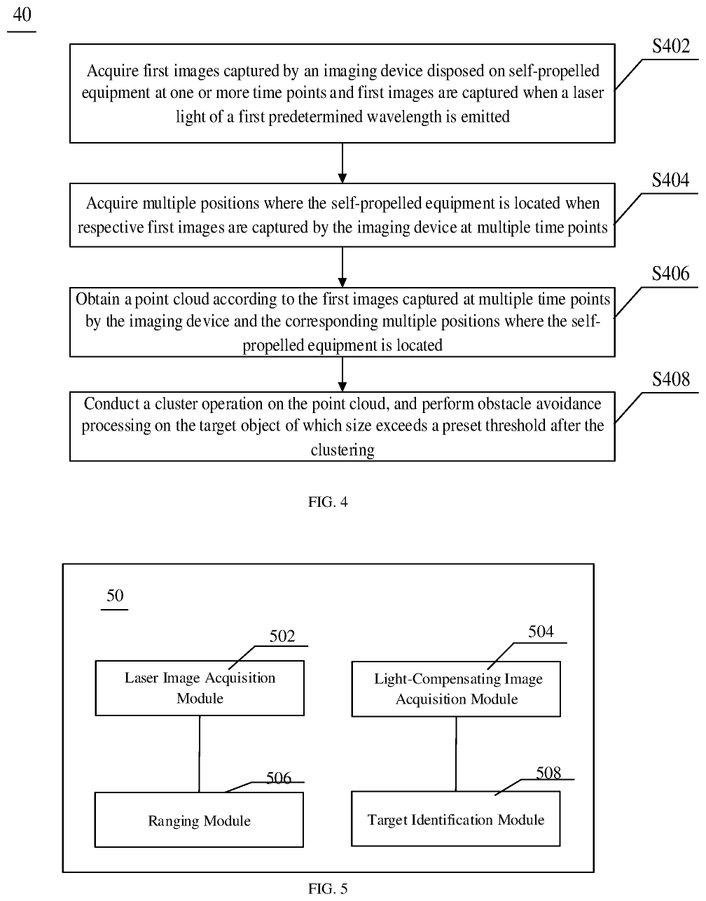

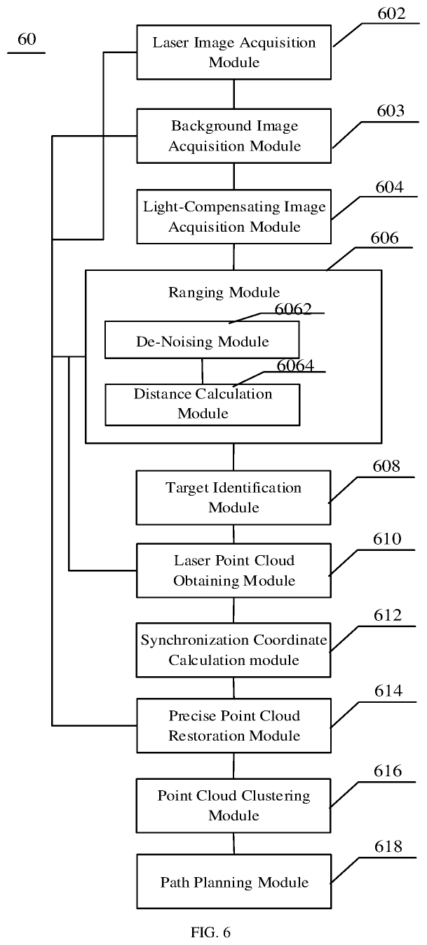

As shown in FIG. 1A, the target detection system 10 may be a mobile device, such as a cleaning robot, a service robot, etc. The system 10 includes an imaging device 102, a laser emitting device 104, a light-compensating device 106 and a control module (not shown). The imaging device 102 may be a camera device including a camera and a Charge Coupled Device (CCD), and is also provided with an optical filter to ensure that only a light of a specific wavelength can pass through the optical filter and its image will be captured by the camera. The laser emitting device 104 can be a line laser emitter, a structured light emitter, or a surface laser emitter, etc., and can be used to emit an infrared laser light, for example, a line laser light with a wavelength of 850 nm. The light-compensating device 106 may be a light-compensating device capable of emitting infrared light within a certain wavelength band, which may include the wavelength of the laser light emitted by the laser emitting device 104. For example, a filter that allows the passage of a narrow band of 850 nm can be used. The relationship between the transmittance and the wavelength of the optical filter is shown in FIG. 1B, and the optical filter can also transmit infrared light in a wavelength band of about 850 nm. The control module may be a target detection apparatus, and the specific implementation thereof can be referred to FIG. 5 and FIG. 6, which will not be described in detail here.

FIG. 1C shows a left side view of the exemplary system of FIG. 1A. As shown in FIG. 1C, the infrared light emitted by the laser emitting device 104 and the light-compensating device 106 can be irradiated on one or more obstacles in front of the system 10, and the imaging device 102 can shoot the obstacles irradiated by the laser emitting device 104 and the light-compensating device 106 respectively. Shooting can be controlled by the control module in a time-division manner. For example, the laser emitting device 104 and the light-compensating device 106 are turned on alternately, and a laser image (i.e., a first image) captured by the imaging device 102 is used for ranging, that is, the distance measurement. A second image captured when the light-compensating device 106 is turned on is used for obstacle identification. When the laser image is captured by the imaging device 102, a fixed exposure may be used, that is, fixed exposure parameters can be set, which includes an exposure time and an exposure gain, etc. When the image irradiated by the light-compensating device 106 (i.e., the second image) is captured by the imaging device 102, an automatic exposure may be used, that is, adjusting exposure parameters by referring to a previous frame of second image which is used for the target identification. Furthermore, the exposure time and the exposure gain can be adjusted according to the imaging quality of a previous second image (such as, picture brightness, the number of feature points in the picture, etc.). The advantage of automatic exposure is to improve the imaging quality by changing the exposure parameters, thereby improving the recognition rate of obstacles and improving the user experience.

It should be understood that the numbers of imaging devices, laser emitting devices, and light-compensating devices in FIG. 1A and FIG. 1C are only illustrative. According to implementation requirements, there may be any number of imaging devices, laser emitting devices, and light-compensating devices. For example, the laser emitting device 104 can be two line laser emitters disposed on left and right sides of the imaging device, or disposed on the same side of the imaging device. When the two line laser emitters are disposed on the left and right sides of the imaging device, the heights of the two line laser emitters in the horizontal direction are the same, and the optical axes of them has an intersection in a traveling direction of the self-propelled equipment. When the two line laser emitters are disposed on the same side of the imaging device, the two line laser emitters can be disposed side by side along a height direction of the self-propelled equipment.

According to the target detection system provided by the embodiment of the present disclosure, the effects of ranging and identifying can be achieved at the same time by multiplexing one imaging device on the self-propelled equipment, so that the obstacle identification can be performed while ranging the target object, so as to achieve a better planning of navigation paths and improves system compactness and saves costs.

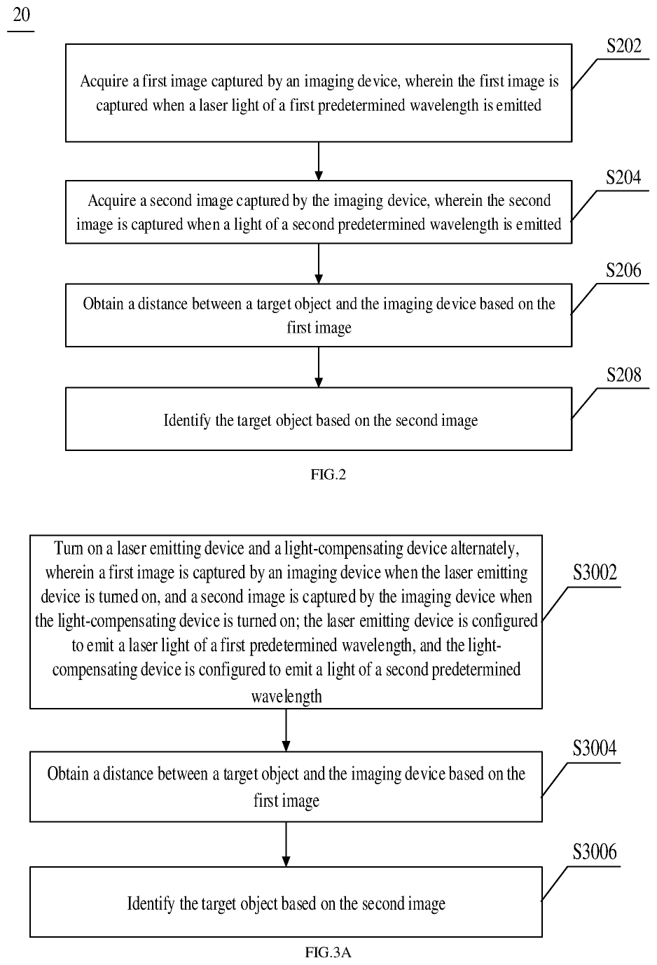

FIG. 2 is a flow chart of a target detection method according to an exemplary embodiment. The method shown in FIG. 2 can be applied, for example, to the above-mentioned target detection system 10.

Referring to FIG. 2, the method 20 provided by the embodiment of the present disclosure may include the following steps.

In a step S202, a first image captured by an imaging device is acquired, and the first image is captured when a laser light of a first predetermined wavelength is emitted. For the specific implementation of the apparatus involved in the method, reference may be made to FIG. 1A to FIG. 1C, which will not be repeated here.

In a step S204, a second image captured by the imaging device is acquired, and the second image is captured when a light of a second predetermined wavelength is emitted. The laser light of the first predetermined wavelength and the light of the second predetermined wavelength may have the same wavelength or different wavelengths, which are not limited herein. The laser emitting device can be used for emitting the laser light of the first predetermined wavelength, and the light-compensating device can be used for emitting the light of the second predetermined wavelength, both of which may use an infrared light source. The imaging device can use a camera that only allows the passage of part of the infrared wavelength, for example, a camera with a set optical filter, to ensure that the light of a wavelength between the first predetermined wavelength and the second predetermined wavelength can be captured by the camera, so as to filter out exterior light source interferences as much as possible and ensure the imaging accuracy.

In some embodiments, for example, the imaging device alternately captures the first image and the second image, which can be realized by controlling the laser emitting device and the light-compensating device to be turned on alternately, and setting the exposure parameters of the imaging device accordingly. For example, the time when the laser emitting device is turned on to emit the laser light is the same as the exposure time of the imaging device, and the laser image (i.e., the first image) is captured by the imaging device according to first exposure parameters, and the first exposure parameters include a preset fixed exposure time and a preset fixed exposure gain; the light-compensating image (i.e., the second image) is captured by the imaging device according to the second exposure parameters, and the second exposure parameters are obtained according to the imaging quality of the captured previous frame of light-compensating image and combined with the exposure parameter of the imaging device at that time, that is, at the time of capturing the previous frame of light-compensating image. For example, if the image quality in the previous frame of light-compensating image is poor, the exposure parameters of current frame is adjusted to a value that helps to improve the image quality.

In a step S206, a distance between the target object and the imaging device is obtained according to the first image.

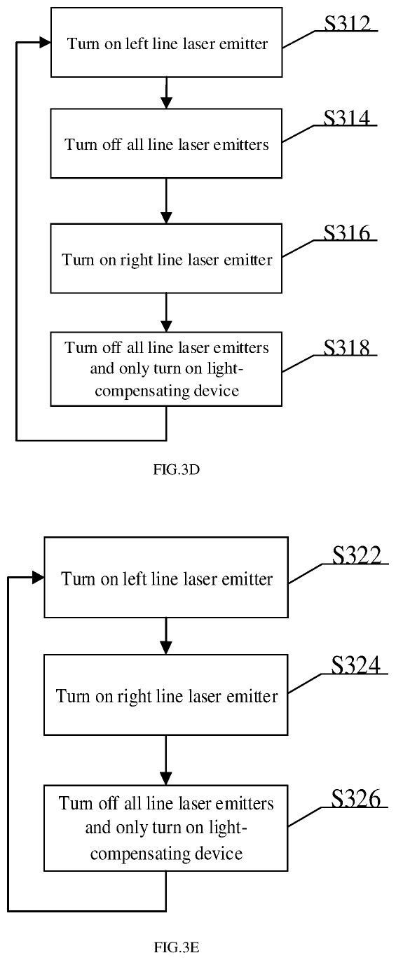

In some embodiments, for example, when more than one laser emitter (e.g., the line laser emitter) are used (such as two laser emitter), three-dimensional coordinates of each point that the line laser irradiates the target object, relative to the imaging device can be calculated based on the principle of laser ranging and rating data, and then by combining with a relative position of the imaging device on the self-propelled equipment and real-time SLAM coordinates of the self-propelled equipment, three-dimensional coordinates of each point on the line laser in a SLAM coordinate system can be calculated. When the self-propelled equipment moves on its own, the point cloud of the target objects encountered during the movement of the self-propelled equipment can be constructed. By clustering the point cloud, obstacle avoidance processing can be performed for target objects larger than a certain height and/or width threshold (alternatively, for the target objects having a height between the threshold mentioned above and the height that can be got over by self-propelled equipment itself, crossing processing can be performed). The specific implementation can refer to FIG. 4.

In a step S208, a target object is identified according to the second image. For the image of the target object captured by the imaging device, global and/or local features of the target object in the three-dimensional space can be extracted through a neural network such as a trained machine learning model, and the category of the target object can be identified by comparing shapes of the target object in the image and a reference object, in order to better implement different obstacle avoidance path planning according to its category (such as fabrics that are easily involved, threads, pet feces, bases, etc.), thus ensuring that on the basis of maximizing the cleaning coverage rate, it does not cause unnecessary damage to its working environment, reduces the risk of stuck, and improves the user experience.

According to the target detection method provided by the embodiment of the present disclosure, by acquiring the first image captured by the imaging device when the laser light of the first predetermined wavelength is emitted and acquiring the second image captured by the imaging device when the light of the second predetermined wavelength is emitted, obtaining the distance between the target object and the imaging device according to the first image, and identifying the target object according to the second image, the obstacle can be identified while the distance between the target object and the imaging device is measured, and the rationality of obstacle avoidance path planning can be improved.

The target detection method provided by disclosed embodiments realizes obstacle identification while ranging the target object through time-division multiplexing of the same imaging device, which improves the rationality of obstacle avoidance path planning and saves costs. In addition, according to the results of laser ranging, the location of obstacles in the direction of travel can be confirmed more accurately, and the navigation path is planned more accurately, so as to further reduce the accidental collision of obstacles in the working environment.

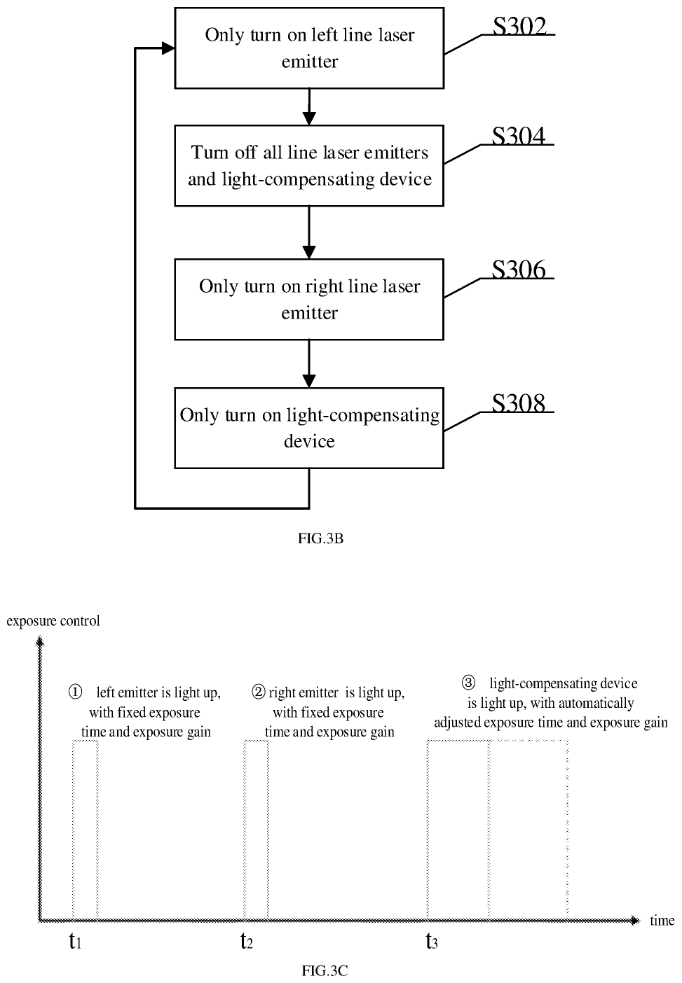

FIG. 3A shows a schematic flowchart of a time-division control performed by a target detection system in an embodiment of the present disclosure. FIG. 3A shows a case where one line laser emitter is provided. As shown in FIG. 3A, in a step S3002, the laser emitting device (i.e., the line laser emitter) and the light-compensating device are controlled to be turned on alternately. Wherein, the imaging device captures and obtains the first image when the laser emitting device is turned on, and captures and obtains the second image when the light-compensating device is turned on. The laser emitting device is used for emitting the laser light of the first predetermined wavelength, and the light-compensating device is used for emitting the light of the second predetermined wavelength. In a step S3004, the distance between the target object and the imaging device is obtained according to the first image. In a step S3006, the target object is identified according to the second image.

Multiple laser emitting devices can be used to obtain multiple first images. For example, two line laser emitters can be disposed on the left and right sides of the imaging device, and the first image includes a first laser image and a second laser image. In order to avoid two laser images are confused in identification, which affects the generation of correct coordinates of the target object in front of the laser emitting devices, the first laser image and the second laser image are obtained by the imaging devices in the time-division manner, that is, the first laser image is captured when the left line laser emitter emits the laser light of the first predetermined wavelength and irradiates the target object at a first angle, and the second laser image is captured when the right line laser emitter emits the laser light of the first predetermined wavelength and irradiates the target object at a second angle. The first angle is an angle between a direction of the laser light emitted by the left line laser emitter and an optical axis of the imaging device, and the second angle is an angle between a direction of the laser light emitted by the right line laser emitter and the optical axis of the imaging device. The values of the first angle and the second angle may be the same or different, which are not limited here. The two line laser emitters can be placed side by side on the self-propelled equipment in the horizontal direction, and the optical axis is in the traveling direction of the self-propelled equipment, in this case, the first angle and the second angle are the same. When performing ranging (i.e., when measuring the distance between the target object and the imaging device), based on the principle of laser ranging, three-dimensional coordinates of points at which the laser light of the first predetermined wavelength irradiates the target object at the first angle and the second angle respectively, relative to the imaging device, can be calculated from the first laser image and the second laser image. After multiple image acquisitions by the imaging device, coordinate information of the obstacles encountered during the traveling process can be obtained. FIG. 3B shows a schematic flowchart of time-division control performed by another target detection system in an embodiment of the present disclosure. In FIG. 3B, two line laser emitters are disposed on the left and right sides of the imaging device. As shown in FIG. 3B, only the left line laser emitter is firstly turned on (S302), then all line laser emitters and light-compensating device are turned off (S304), and then only the right line laser emitter is turned on (S306), and next only the light-compensating device is turned on (S308). The above steps are repeated when the self-propelled equipment moves. In terms of the imaging device, FIG. 3C shows a time-division control timing diagram in an embodiment of the present disclosure according to FIG. 3B, the imaging device uses a fixed exposure at time t₁, and the time when the left line laser emitter is turned on (S302) is consistent with the exposure time of the imaging device. The imaging device uses a fixed exposure at time t₂, and the time when the right line laser emitter is turned on (S306) is consistent with the exposure time of the imaging device, and the light-compensating device is turned on at time t₃, the imaging device uses an automatic exposure at time t₃, and the exposure parameters thereof are based on the previous frame for identifying the target object. The exposure parameters include the exposure time and/or the exposure gain, that is, the first image is captured by the imaging device under the preset first exposure parameters, and the second image is captured by the imaging device under the second exposure parameters, and the second exposure parameters can be obtained according to the imaging quality of the captured previous second image frame and the exposure parameters when capturing the previous second image frame.

In some embodiments, the imaging device may capture a third image in a step S304, the laser light of the first predetermined wavelength and the light of the second predetermined wavelength are not emitted when capturing the third image, that is, the target object is not irradiated by the laser light or light-compensating. The third image is used to perform operations with the images in steps S302 and S306 to remove background noise and further reduce the influence of lights, strong light, etc. One image may also be taken after the step S306 (that is, one image can be taken when all laser emitting devices and light-compensating devices are turned off). The purpose of taking this image after the step S306 is to make a difference between pixel points in the first image and pixel points at corresponding positions in the third image to obtain a corrected laser image, so as to reduce the influence of external light sources on the line laser as much as possible. For example, if the target object is irradiated by natural light at this time, a natural light image is obtained to optimize the laser ranging results of the target object in the scene under sunlight, and then the distance between the target object and the imaging device can be obtained according to the corrected laser image.

FIG. 3D shows a schematic flowchart of time-division control performed by yet another target detection system according to an embodiment of the present disclosure. In FIG. 3D, the first predetermined wavelength of the laser light emitted by the line laser emitter is different from the second predetermined wavelength of the light emitted by the light-compensating device. As shown in FIG. 3D, the left line laser emitter is firstly turn on (S312) (at this time, the right line laser emitter is turned off and the light-compensating device can in a turn-on state), and the first laser image is captured; then all line laser emitters are turned off (S314) to capture the third image; next the right line laser emitter is turn on again (S316), in order to capture the second laser image; after that, all line laser emitters are turn off (S318) and only the light-compensating device is turn on, to capture the second image. The above steps are repeated as the self-propelled equipment moves. For specific implementations of capturing images and performing processing according to the images, reference may be made to FIG. 3A and FIG. 3C. Since the values of the first wavelength and the second wavelength are not the same, so whether the light-compensating device is turned on when the third image is captured does not affect the generation of the final corrected laser image, thus simplifying the control logic.

FIG. 3E shows a schematic flowchart of time-division control performed by yet another target detection system according to an embodiment of the present disclosure. In FIG. 3E, the positions of two line laser emitters are staggered up and down, that is, not on a line, and laser lights emitted when the two line laser emitters are turned on at the same time do not intersect. As shown in FIG. 3E, the left line laser emitter is firstly turned on (S322) (at this time, the right line laser emitter and the light-compensating device might be turned on), and the first laser image is captured; then the right line laser emitter is turned on (S324) (and at this time, there is no need to turn off the left line laser emitter), the second laser image is captured (this second laser image can also be used as the third image); next all line laser emitters are turned off (S326) and only the light-compensating device is turned on, so as to capture the second image. Since the upper and lower line laser images in the first image will not cause the positional relationship between the line laser and the camera to be unrecognized and thus affect the calculation of SLAM coordinates, and the noise of the two line laser images are similar, in this case, a difference between pixel points in the first laser image and the pixel points in corresponding positions in the second laser image can be calculated to obtain a corrected laser image. The above steps can be repeated as the self-propelled equipment moves. For specific implementations of obtaining images and performing processing according to the images, reference may be made to FIG. 3A and FIG. 3C.

FIG. 4 is a flow chart of an obstacle avoidance method for self-propelled equipment according to an exemplary embodiment. For example, the method shown in FIG. 4 can be applied to the above-mentioned target detection system 10.

Referring to FIG. 4, the method 40 provided by the embodiment of the present disclosure may include the following steps.

In a step S402, first images captured by an imaging device disposed on self-propelled equipment at multiple time points are acquired, and the first images are captured when a laser light of a first predetermined wavelength are emitted. For the specific implementation manner of capturing the first images, reference may be made to FIG. 2.

In a step S404, multiple positions where the self-propelled equipment is located when the imaging device captures respective first images at multiple time points are acquired. Among them, the self-propelled equipment moves relative to the target object at multiple time points.

In a step S406, a point cloud is obtained according to the first images captured at multiple time points by the imaging device and the multiple corresponding positions of the self-propelled equipment during the capturing. For example, if the self-propelled equipment is at coordinates A, distances relative to points on which the line laser irradiates the target object at multiple time points (that is, distances between these points and the imaging device) can be measured, and then SLAM three-dimensional coordinates of these points can be calculated. The self-propelled equipment may be at coordinates B after moves or rotates, then if the line laser also irradiates the target object, the distance measurement, i.e., the ranging, is also performed, and SLAM three-dimensional coordinates of other points on the target object can be calculated. Through the continuous motion of the self-propelled equipment, the point cloud of the target object can be obtained.

In some embodiments, the corrected laser image may also be obtained according to FIG. 2 to FIG. 3D, and the point cloud may be obtained according to the corrected laser image.

In a step S408, the point cloud is clustered, and obstacle avoidance processing is performed on the target object whose size exceeds a preset threshold after the clustering. When the distance from the target object whose size exceeds the preset threshold is less than or equal to a preset distance, the self-propelled equipment can be controlled to bypass; wherein, the preset distance is greater than 0, and its value can be related to the identified obstacle type. That is, for different types of obstacles identified, the preset distance will have different numerical settings. Of course, the value of the preset distance can also be a fixed value, which is suitable for target objects whose type cannot be determined.

In some embodiments, based on the principle of monocular ranging, synchronized coordinates of at least some points on the target object may be obtained according to the second image captured when the light-compensating device is turned on. According to the synchronization coordinates of at least some points above, these points are supplemented to an initial point cloud of the target object (that is, a point cloud obtained by the image captured by the imaging device and by using the light emitted with the laser emitting device), and a dense point cloud of the target object is obtained. In detail, current SLAM coordinates of the self-propelled equipment can be estimated through the monocular ranging, and can be combined with the point cloud information obtained through the first image, so as to construct the point cloud of the target object to realize more accurate obstacle avoidance. For example, some point clouds and their three-dimensional information are calculated, and then, according to the three-dimensional information calculated by the monocular ranging, the identified objects are associated with the point cloud data to obtain denser point cloud data.

According to the obstacle avoidance method for self-propelled equipment provided by the embodiments of the present disclosure, the effects of distance measurement (i.e., ranging) and identification are simultaneously achieved by multiplexing the imaging device on the equipment, and the identification result is used to accurately restore the object point cloud, thereby improving the accuracy and rationality of the obstacle avoidance strategy.

The embodiments of the present disclosure also provide self-propelled equipment, including: a driving device for driving the self-propelled equipment to walk along a working surface; a sensing system, including a target detection system, and the target detection system includes a laser emitting device, a light-compensating device, an imaging device and an infrared filter, wherein the laser emitting device is used to emit a laser light of a first wavelength; the light-compensating device is used to emit an infrared light of a second wavelength; the values of the first wavelength and the second wavelength may be equal or unequal; the infrared filter is disposed in front of the imaging device and is used for filtering the light incident on the imaging device. The lights of the first wavelength and the second wavelength can be incident to the imaging device through the infrared filter; and the imaging device is used to capture images.

In some embodiments, the laser emitting device and the light-compensating device alternately emit lights of respective wavelengths. When the above-mentioned laser emitting device is working, the first image is captured by the imaging device; when the light-compensating device is working, the second image is captured by the imaging device. The self-propelled equipment further includes a control unit, the control unit obtains the distance between the target object and the imaging device based on the first image and identifies the target object based on the second image.

FIG. 5 shows a block diagram of a target detection apparatus according to an exemplary embodiment. The apparatus shown in FIG. 5 can be applied to, for example, the above-mentioned target detection system 10.

Referring to FIG. 5, the apparatus 50 provided by the embodiment of the present disclosure may include a laser image acquisition module 502, a light-compensating image acquisition module 504, a ranging module 506, and an object identification module 508.

The laser image acquisition module 502 is configured to acquire a first image captured by an imaging device, wherein the first image is captured when a laser light of a first predetermined wavelength is emitted.

The light-compensating image acquisition module 504 is configured to acquire a second image captured by the imaging device, wherein the second image is captured when a light of a second predetermined wavelength is emitted.

The ranging module 506 is configured to obtain a distance between the target object and the imaging device based on the first image.

The target identification module 508 is configured to identify the target object based on the second image.

FIG. 6 shows a block diagram of another target detection apparatus according to an exemplary embodiment. The apparatus shown in FIG. 6 can be applied to, for example, the above-mentioned target detection system 10.

Referring to FIG. 6, an apparatus 60 provided by an embodiment of the present disclosure may include a laser image acquisition module 602, a background image acquisition module 603, a light-compensating image acquisition module 604, a ranging module 606, a target identification module 608, a laser point cloud acquisition module 610, a synchronous coordinate calculation module 612, an precise point cloud restoration module 614, a point cloud clustering module 616 and a path planning module 618. The ranging module 606 may include a de-noising module 6062 and a distance calculation module 6064.

The laser image acquisition module 602 is configured to acquire a first image captured by an imaging device, wherein the first image is captured when a laser light of a first predetermined wavelength is emitted.

The first image includes a first laser image and a second laser image. The first laser image is captured by irradiating the target object with the laser light of the first predetermined wavelength at a first angle, and the second laser image is captured by irradiating the target object with the laser light of the first predetermined wavelength at a second angle.

The first image is captured by the imaging device under preset first exposure parameters; wherein the exposure parameters comprises an exposure time and/or an exposure gain.

The background image acquisition module 603 is configured to acquire a third image captured by the imaging device, wherein the third image is captured when emitting the laser light of the first predetermined wavelength is stopped.

The light-compensating image acquisition module 604 is configured to acquire a second image captured by the imaging device, wherein the second image is captured when a light of a second predetermined wavelength is emitted.

The imaging device alternately captures the first image and the second image.

The second image is captured by the imaging device under second exposure parameters, and the second exposure parameters are obtained according to imaging quality of a captured previous second image frame and exposure parameters when capturing the previous second image frame

The ranging module 606 is configured to obtain the distance between the target object and the imaging device according to the first image.

The ranging module 606 is further configured to, according to the principle of laser ranging, calculate three-dimensional coordinates, relative to the imaging device, of points at which the laser light of the first predetermined wavelength irradiates the target object at the first angle and the second angle, respectively, based on the first laser image and the second laser image.

The de-noising module 6062 is configured to obtain a corrected laser image by calculating a difference between pixel points in the first image and pixel points at corresponding positions in the third image.

The distance calculation module 6064 is configured to obtain the distance between the target object and the imaging device based on the corrected laser image.

The target identification module 608 is configured to identify the target object based on the second image.

The laser point cloud obtaining module 610 is configured to obtain a point cloud according to the first images captured by the imaging device at the plurality of time points and the plurality of positions where the self-propelled equipment is located.

The synchronous coordinate calculation module 612 is configured to acquire a plurality of positions where the self-propelled equipment is located when respective images are captured by the imaging device at the plurality of time points.

The precise point cloud restoration module 614 is configured to obtain a dense point cloud of the target object by supplementing supplementary points to the initial point cloud of the target object based on synchronous coordinates of the supplementary points.

The point cloud clustering module 616 is configured to cluster point clouds.

The path planning module 618 is configured to perform obstacle avoidance processing on target objects whose size exceeds a preset threshold after clustering. The preset threshold for the obstacle avoidance processing can be related to the identified obstacle type, that is, for different types of identified obstacles, the preset distance will have different numerical settings. Of course, its value can also be a fixed value, which is suitable for target objects whose type cannot be determined.

The path planning module 618 is further configured to control the self-propelled equipment to bypass when the distance from the target object whose size exceeds the preset threshold is less than or equal to a preset distance; wherein the preset distance is greater than 0.

For the specific implementation of each module in the apparatus provided by the embodiment of the present disclosure, reference may be made to the content in the foregoing method, which will not be repeated here.

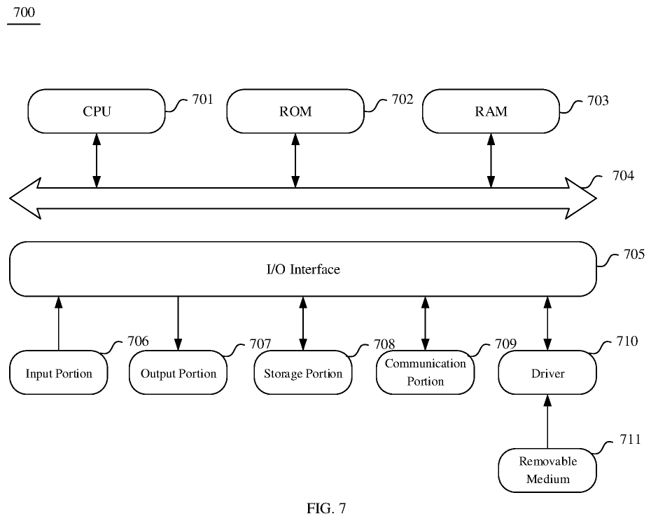

FIG. 7 shows a schematic structural diagram of an electronic device according to an embodiment of the present disclosure. It should be noted that the device shown in FIG. 7 is only an example of a computer system, and should not bring any limitation to the function and scope of use of the embodiment of the present disclosure.

As shown in FIG. 7, the computer system 700 includes a central processing unit (CPU) 701, which can perform various appropriate actions and processing based on a program stored in a read-only memory (ROM) 702 or a program loaded from a storage portion 708 into a random access memory (RAM) 703. In RAM 703, various programs and data required for system operation are also stored. The CPU 701, the ROM 702, and the RAM 703 are connected to each other through a bus 704. An input/output (I/O) interface 705 is also connected to the bus 704.

The following components are connected to the I/O interface 705: an input portion 706 including a keyboard, a mouse, etc.; an output portion 707 including a cathode ray tube (CRT), a liquid crystal display (LCD), etc., and speakers, etc.; a storage portion 708 including a hard disk, etc.; and a communication portion 709 including a network interface card such as a LAN card, a modem, and the like. The communication portion 709 performs communication processing via a network such as the Internet. The driver 77 is also connected to the I/O interface 705 as required. A removable medium 711, such as a magnetic disk, an optical disk, a magneto-optical disk, a semiconductor memory, etc., is installed on the driver 77 as required, so that the computer program read from removable medium 711 is installed into the storage part 708 as required.

In particular, according to an embodiment of the present disclosure, the process described above with reference to the flowchart can be implemented as a computer software program. For example, an embodiment of the present disclosure includes a computer program product, which includes a computer program carried on a computer-readable medium, and the computer program contains program code for executing the method shown in the flowchart. In such an embodiment, the computer program may be downloaded from the network through the communication portion 709 and installed, and/or downloaded from the removable medium 711 and installed. When the computer program is executed by the central processing unit (CPU) 701, it executes the above-mentioned functions defined in the system of the present disclosure.

It should be noted that the computer-readable medium shown in the present disclosure may be a computer-readable signal medium or a computer-readable storage medium, or any combination of the both. The computer-readable storage medium may be, for example, but not limited to, an electrical, magnetic, optical, electromagnetic, infrared, or semiconductor system, apparatus, or device, or a combination of any of the above. More specific examples of computer-readable storage media may include, but are not limited to: electrical connections with one or more wires, portable computer disks, hard disks, random access memory (RAM), read-only memory (ROM), erasable programmable read-only memory (EPROM or flash memory), optical fiber, portable compact disk read-only memory (CD-ROM), optical storage device, magnetic storage device, or any suitable combination of the above. In the present disclosure, the computer-readable storage medium may be any tangible medium that contains or stores a program, and the program may be used by or in combination with an instruction execution system, apparatus, or device. In the present disclosure, a computer-readable signal medium may include a data signal propagated in a baseband or propagated as a part of a carrier wave, and a computer-readable program code is carried therein. This propagated data signal can take many forms, including but not limited to electromagnetic signals, optical signals, or any suitable combination of the foregoing. The computer-readable signal medium may also be any computer-readable medium other than the computer-readable storage medium. The computer-readable medium may send, propagate or transmit the program for use by or in combination with the instruction execution system, apparatus, or device. The program code contained on the computer-readable medium can be transmitted by any suitable medium, including but not limited to: wireless, wire, optical cable, RF, etc., or any suitable combination of the foregoing.

The flowcharts and block diagrams in the accompanying drawings illustrate possible implementation architecture, functions, and operations of the system, method, and computer program product according to various embodiments of the present disclosure. At this point, each block in the flowchart or block diagram can represent a module, program segment, or a part of code, and the above-mentioned module, program segment, or the part of code contains executable instructions for realizing the specified logic function. It should also be noted that, in some alternative implementations, the functions marked in the block may also occur in a different order from the order marked in the drawings. For example, two blocks shown one after the other can actually be executed substantially in parallel, or they can sometimes be executed in the reverse order, depending on the functions involved. It should also be noted that each block in the block diagram or flowchart, and the combination of blocks in the block diagram or flowchart can be implemented by a dedicated hardware-based system that performs the specified function or operation, or can be realized by a combination of dedicated hardware and computer instructions.

The modules described in the embodiments of the present disclosure may be implemented in software or hardware, and the described modules may also be provided in a processor. For example, it can be described as: a processor includes a laser image acquisition module, a light-compensating image acquisition module, a ranging module and a target identification module. The names of these modules do not limit the module itself in some cases, for example, the laser image module can also be described as “a module that captures the image of the target object irradiated by laser via the connected imaging device”.

As another aspect, the present disclosure also provides a computer-readable medium. The computer-readable medium may be included in the device described in the above-mentioned embodiments, or it may exist alone without being assembled into the device. The above-mentioned computer-readable medium carries one or more programs, and when the above-mentioned one or more programs are executed by a device, the device is configured to: acquire the first image captured by the imaging device, wherein the first image is captured when a laser light of a first predetermined wavelength is emitted; acquire a second image captured by the imaging device, wherein the second image is captured when a light of a second predetermined wavelength is emitted, obtain a distance between a target object and the imaging device based on the first image; and identify the target object based on the second image.

Exemplary embodiments of the present disclosure have been specifically shown and described above. It should be understood that this disclosure is not limited to the details of construction, arrangements, or implementations described herein; on the contrary, this disclosure is intended to cover various modifications and equivalent arrangements included within the spirit and scope of the appended claims.

What is claimed is:

1. A target detection method, comprising:
acquiring a first image captured by an imaging device, wherein the first image is captured when a laser light of a first predetermined wavelength is emitted;
acquiring a second image captured by the imaging device, wherein the second image is captured when a light of a second predetermined wavelength is emitted, and the laser light of the first predetermined wavelength and the light of the second predetermined wavelength have a same wavelength or different wavelengths;
obtaining a distance between a target object and the imaging device based on the first image; and
identifying the target object based on the second image.

2. The method according to claim 1, wherein the first image comprises a first laser image and a second laser image,
the first laser image is captured by irradiating the target object with the laser light of the first predetermined wavelength at a first angle,
the second laser image is captured by irradiating the target object with the laser light of the first predetermined wavelength at a second angle;
wherein the obtaining the distance between the target object and the imaging device based on the first image comprises:
calculating three-dimensional coordinates, relative to the imaging device, of points at which the laser light of the first predetermined wavelength irradiates the target object at the first angle and the second angle, respectively, based on the first laser image and the second laser image.

3. The method according to claim 1, further comprising:
acquiring a third image captured by the imaging device, wherein the third image is captured when emitting the laser light of the first predetermined wavelength and the light of the second predetermined wavelength is stopped,
wherein the obtaining the distance between the target object and the imaging device based on the first image further comprises:
obtaining a corrected laser image by calculating a difference between pixel points in the first image and pixel points at corresponding positions in the third image; and
obtaining the distance between the target object and the imaging device based on the corrected laser image.

4. The method according to claim 1, wherein the first image and the second image are captured alternately by the imaging device.

5. The method according to claim 1, wherein the first image is captured by the imaging device under preset first exposure parameters;
the second image is captured by the imaging device under second exposure parameters, and the second exposure parameters are obtained according to imaging quality of a captured previous second image frame and exposure parameters when capturing the previous second image frame;
wherein the exposure parameters comprises an exposure time and/or an exposure gain.

6. A target detection control method, comprising:
turning on a laser emitting device and a light-compensating device alternately, wherein a first image is captured by an imaging device when the laser emitting device is turned on, and a second image is captured by the imaging device when the light-compensating device is turned on; the laser emitting device is configured to emit a laser light of a first predetermined wavelength, and the light-compensating device is configured to emit a light of a second predetermined wavelength;
obtaining a distance between a target object and the imaging device based on the first image; and
identifying the target object based on the second image.

7. The method according to claim 6, wherein the laser emitting device comprises a first laser emitting device and a second laser emitting device, the first image comprises a first laser image and a second laser image,
the first laser image is captured by the imaging device when the first laser emitting device is turned on, and the second laser image is captured by the imaging device when the second laser emitting device is turned on;
the first laser image is captured by irradiating the target object with the laser light of the first predetermined wavelength emitted by the first laser emitting device at a first angle,
the second laser image is captured by irradiating the target object with the laser light of the first predetermined wavelength emitted by the second laser emitting device at a second angle;
wherein the obtaining the distance between the target object and the imaging device based on the first image comprises:
calculating three-dimensional coordinates, relative to the imaging device, of points at which the laser light of the first predetermined wavelength irradiates the target object at the first angle and the second angle, respectively, based on the first laser image and the second laser image.

8. The method according to claim 6, further comprising:
turning off the laser emitting device and the light-compensating device; wherein a third image is captured by the imaging device when the laser emitting device and the light-compensating device are turned off,
wherein the obtaining the distance between the target object and the imaging device based on the first image comprises:
obtaining a corrected laser image by calculating a difference between pixel points in the first image and pixel points at corresponding positions in the third image;
obtaining the distance between the target object and the imaging device based on the corrected laser image.

9. The method according to claim 6, wherein the first image is captured by the imaging device under preset first exposure parameters;
the second image is acquired by the imaging device under second exposure parameters, and the second exposure parameters are obtained according to imaging quality of a captured previous second image frame and exposure parameters when capturing the previous second image frame;
wherein the exposure parameters comprises an exposure time and/or an exposure gain.

10. A target detection system, comprising a laser emitting device, a light-compensating device, an imaging device and a target detection device, wherein:
the laser emitting device is configured to emit a laser light of a first predetermined wavelength;
the light-compensating device is configured to emit a light of a second predetermined wavelength, and the laser light of the first predetermined wavelength and the light of the second predetermined wavelength have a same wavelength or different wavelengths;
the imaging device is configured to capture a first image when the laser light of the first predetermined wavelength is emitted, and capture a second image when the light of the second predetermined wavelength is emitted;
the target detection device comprises:
a ranging module configured to obtain a distance between a target object and the imaging device based on the first image;
an object identification module configured to identify the target object based on the second image.

11. Self-propelled equipment comprising the target detection system according to claim 10, wherein the Self-propelled equipment further comprises a driving device configured to drive the self-propelled equipment to walk along a working surface.

12. The self-propelled equipment according to claim 11, wherein the laser emitting device and the light compensating device alternately emit the laser light of the first wavelength and the infrared light of the second wavelength.

13. The self-propelled equipment according to claim 12, wherein,
a first image is captured by the imaging device when the laser emitting device is working;
a second image is acquired by the imaging device when the light-compensating device is working;
the self-propelled equipment further comprises a control unit, the control unit is configured to obtain a distance between a target object and the imaging device based on the first image and identify the target object based on the second image.

14. A method for controlling self-propelled equipment according to claim 11, comprising:
acquiring first images captured by an imaging device disposed on the self-propelled equipment at a plurality of time points, wherein the first images are captured when a laser light of a first predetermined wavelength is emitted;
acquiring a plurality of positions where the self-propelled equipment is located when respective images are captured by the imaging device at the plurality of time points;
obtaining a point cloud according to the first images captured by the imaging device at the plurality of time points and the plurality of positions where the self-propelled equipment is located; and
clustering the point cloud and conducting a navigation planning for the self-propelled equipment according to a clustering result.

15. The method according to claim 14, wherein the conducting the navigation planning for the self-propelled equipment according to the clustering result comprises:
obtaining the clustering result, wherein the clustering result comprises a target object of which size exceeds a preset threshold; and
controlling the self-propelled equipment to bypass when a distance between the self-propelled equipment and the target object of which size exceeds the preset threshold is less than or equal to a preset distance;
wherein a value of the preset distance is greater than 0.

16. The method according to claim 14, wherein,
the first image comprises a first laser image and a second laser image,
the first laser image is captured by irradiating the target object with the laser light of the first predetermined wavelength at a first angle, and
the second laser image is captured by irradiating the target object with the laser light of the first predetermined wavelength at a second angle.

17. The method according to claim 14, further comprising:
acquiring a third image captured by the imaging device, wherein the third image is captured when emitting the laser light of the first predetermined wavelength is stopped;
obtaining a corrected laser image by calculating a difference between pixel points in the first image and pixel points at corresponding positions in the third image;
wherein obtaining the point cloud according to the first images captured by the imaging device at the plurality of time points and the plurality of positions where the self-propelled equipment is located comprises:
obtaining the distance between the target object and the imaging device according to a plurality of corrected laser images corresponding to the first images captured at the plurality of time points and the plurality of positions where the self-propelled equipment is located.
